(19) United States
(12) Patent Application Publication
(10) Pub. No.: US 2014/0106992 A1
(43) Pub. Date: Apr. 17, 2014

(54) INVERT EMULSION WITH ENCAPSULATED BREAKER FOR WELL TREATMENT

(71) Applicant: HALLIBURTON ENERGY SERVICES, INC., Houston, TX (US)

(72) Inventors: Prajakta R. Patil, Pune (IN); Chaitanya M. Karale, Pune (IN); Rajendra A. Kalgaonkar, Pune (IN)

(73) Assignee: HALLIBURTON ENERGY SERVICES, INC., Houston, TX (US)

(21) Appl. No.: 13/651,801

(22) Filed: Oct. 15, 2012

(51) Int. Cl. C09K 8/575

(52) U.S. Cl. 507/214

(57) ABSTRACT

An emulsion including: (a) an external oil phase, wherein the oil phase has a viscosity of less than 200 cP; (b) an internal water phase adjacent the external phase, wherein the internal water phase has a pH in the range of 5 to 9; (c) an emulsifier having a hydrophilic-lipophilic balance in the range of 3 to 7 on the Davies scale; and (d) a Bronsted-Lowry base having a pKb(1) less than 12, wherein the base is encapsulated with an encapsulated breaker composition comprising: an encapsulant that comprises an ether cellulose. A method of treating a well includes the steps of: forming a treatment fluid including the emulsion; and introducing the treatment fluid into the well. In a preferred embodiment, the emulsion has a viscosity greater than 200 cP.

### CROSS-REFERENCE TO RELATED APPLICATIONS

Not applicable.

### TECHNICAL FIELD

The inventions are in the field of producing crude oil or natural gas from subterranean formations. More specifically, the inventions generally relate to methods of gravel packing a zone of a well using an invert emulsion.

### BACKGROUND

To produce oil or gas, a well is drilled into a subterranean formation that is an oil or gas reservoir. Generally, well services include a wide variety of operations that may be performed in oil, gas, geothermal, or water wells, such as drilling, cementing, completion, and intervention. Well services are designed to facilitate or enhance the production of desirable fluids such as oil or gas from or through a subterranean formation. A well service usually involves introducing a well fluid into a well.

Gravel packing is commonly used as a sand-control method to prevent production of formation sand or other fines from a poorly consolidated subterranean formation. The sand or fines have a tendency to plug small pore spaces in the formation and block the flow of oil. As all the hydrocarbon is flowing from a relatively large region around the wellbore toward a relatively small area around the wellbore, the fines have a tendency to become densely packed and screen out or plug the area immediately around the wellbore. Moreover, the fines are highly abrasive and can be damaging to pumping and oilfield other equipment and operations.

Placing a relatively larger particulate near the wellbore helps filter out the sand or fine particles and prevents them from flowing into the well with the produced fluids. The primary objective is to stabilize the formation while causing minimal impairment to well productivity.

In a common type of gravel packing, a mechanical screen is placed in the wellbore and the surrounding annulus is packed with a particulate of a larger specific size designed to prevent the passage of formation sand or other fines.

A well fluid can be adapted to be a carrier fluid for particulates, such as gravel. Increasing the viscosity of a well fluid can help prevent a particulate having a different specific gravity than a surrounding phase of the fluid from quickly separating out of the fluid.

After a treatment fluid is placed where desired in the well and for the desired time, the fluid usually must be removed from the wellbore or the formation. To accomplish this removal, the viscosity of the treatment fluid must be reduced to a very low viscosity, preferably near the viscosity of water. For example, when a viscosified fluid is used for gravel packing, the viscosified fluid must be removed from the gravel pack.

Reducing the viscosity of a treatment fluid is referred to as “breaking” the fluid. Chemicals used to reduce the viscosity of treatment fluids are called breakers. No particular mechanism is necessarily implied by the term.

Breakers must be selected to meet the needs of each situation. First, it is important to understand the general performance criteria of breakers. In reducing the viscosity of the treatment fluid to a near water-thin state, the breaker must maintain a critical balance. Premature reduction of viscosity during the pumping of a treatment fluid can jeopardize the treatment. Inadequate reduction of fluid viscosity after pumping can also reduce production if the required conductivity is not obtained.

Water-based fluids are typically used for most gravel-packing jobs. Water-based fluids are often considered to be cleaner fluids and have good gravel carrying capability.

However, if the formation is water-sensitive and exposed to the water based fluid for long duration, it may cause instability of the formation. An invert emulsion is a good gravel packing fluid for water sensitive formations. The oil continuous phase of an invert emulsion can prevent clay swelling and migration that would otherwise be caused by contact with water.

Moreover, an invert emulsion can provide an option for carrier fluid for gravel-packing pay zone intervals drilled with oil-based drilling fluids. An invert emulsion can have fluid compatibility with an oil-based drilling fluid. This fluid compatibility can help maintain the highest degree of lubricity of the wellbore, which can aid in the operation of the gravel-pack assembly while providing the highest degree of formation inhibition.

An invert emulsion gravel pack fluid can provide effective gravel transport capability. However, the use of invert emulsions can present problems related to timely breaking of the emulsion.

### SUMMARY OF THE INVENTION

According to an embodiment of the invention, an emulsion is provided, the emulsion including: (a) an external oil phase, wherein the oil phase has a viscosity of less than 200 cP; (b) an internal water phase adjacent the external phase, wherein the internal water phase has a pH in the range of 5 to 9; (c) an emulsifier having a hydrophilic-lipophilic balance (“HLB”) in the range of 3 to 7 on the Davies scale; and (d) a Bronsted-Lowry base having a pKb(1) less than 12, wherein the base is encapsulated with an encapsulated breaker composition comprising: an encapsulant that comprises an ether cellulose. In a preferred embodiment, the emulsion has a viscosity greater than 200 cP.

According to another embodiment of the invention, a method of treating a well, is provided, the method including the steps of: forming a treatment fluid including an emulsion according to the invention; and introducing the treatment fluid into the well.

These and other aspects of the invention will be apparent to one skilled in the art upon reading the following detailed description. While the invention is susceptible to various modifications and alternative forms, specific embodiments thereof will be described in detail and shown by way of example. It should be understood, however, that it is not intended to limit the invention to the particular forms disclosed, but, on the contrary, the invention is to cover all modifications and alternatives falling within the spirit and scope of the invention as expressed in the appended claims.

### DETAILED DESCRIPTION OF PRESENTLY PREFERRED EMBODIMENTS AND BEST MODE

### Definitions and Usages

Interpretation

The words or terms used herein have their plain, ordinary meaning in the field of this disclosure, except to the extent explicitly and clearly defined in this disclosure or unless the specific context otherwise requires a different meaning.

If there is any conflict in the usages of a word or term in this disclosure and one or more patent(s) or other documents that may be incorporated by reference, the definitions that are consistent with this specification should be adopted.

The words “comprising,” “containing,” “including,” “having,” and all grammatical variations thereof are intended to have an open, non-limiting meaning. For example, a composition comprising a component does not exclude it from having additional components, an apparatus comprising a part does not exclude it from having additional parts, and a method having a step does not exclude it having additional steps. When such terms are used, the compositions, apparatuses, and methods that “consist essentially of” or “consist of” the specified components, parts, and steps are specifically included and disclosed.

The control or controlling of a condition includes any one or more of maintaining, applying, or varying of the condition. For example, controlling the temperature of a substance can include maintaining an initial temperature, heating, or cooling.

The indefinite articles “a” or “an” mean one or more than one of the component, part, or step that the article introduces.

Whenever a numerical range of degree or measurement with a lower limit and an upper limit is disclosed, any number and any range falling within the range is also intended to be specifically disclosed. For example, every range of values (in the form “from a to b,” or “from about a to about b,” or “from about a to b,” “from approximately a to b,” and any similar expressions, where “a” and “b” represent numerical values of degree or measurement) is to be understood to set forth every number and range encompassed within the broader range of values.

Oil and Gas Reservoirs

In the context of production from a well, oil and gas are understood to refer specifically to crude oil and natural gas, respectively. Oil and gas are naturally occurring hydrocarbons in certain subterranean formations.

A “subterranean formation” is a body of rock that has sufficiently distinctive characteristics and is sufficiently continuous for geologists to describe, map, and name it.

A subterranean formation having a sufficient porosity and permeability to store and transmit fluids is sometimes referred to as a “reservoir.” The vast majority of reservoir rocks are sedimentary rocks, but highly fractured igneous and metamorphic rocks sometimes contain substantial reservoirs as well.

A subterranean formation containing oil or gas may be located under land or under the seabed off shore. Oil and gas reservoirs are typically located in the range of a few hundred feet (shallow reservoirs) to a few tens of thousands of feet (ultra-deep reservoirs) below the surface of the land or seabed.

Well Terms

A “well” includes a wellhead and at least one wellbore from the wellhead penetrating the earth. The “wellhead” is the surface termination of a wellbore, which surface may be on land or on a seabed. A “well site” is the geographical location of a wellhead of a well. It may include related facilities, such as a tank battery, separators, compressor stations, heating or other equipment, and fluid pits. If offshore, a well site can include a platform.

The “wellbore” refers to the drilled hole, including any cased or uncased portions of the well or any other tubulars in the well. The “borehole” usually refers to the inside wellbore wall, that is, the rock surface or wall that bounds the drilled hole. A wellbore can have portions that are vertical, horizontal, or anything in between, and it can have portions that are straight, curved, or branched. As used herein, “uphole,” “downhole,” and similar terms are relative to the direction of the wellhead, regardless of whether a wellbore portion is vertical or horizontal.

A wellbore can be used as a production or injection wellbore. A production wellbore is used to produce hydrocarbons from the reservoir. An injection wellbore is used to inject a fluid, e.g., liquid water or steam, to drive oil or gas to a production wellbore.

As used herein, introducing “into a well” means introducing at least into and through the wellhead. According to various techniques known in the art, tubulars, equipment, tools, or well fluids can be directed from the wellhead into any desired portion of the wellbore.

As used herein, the word “tubular” means any kind of body in the general form of a tube. Examples of tubulars include, but are not limited to, a drill pipe, a casing, a tubing string, a line pipe, and a transportation pipe. Tubulars can also be used to transport fluids such as oil, gas, water, liquefied methane, coolants, and heated fluids into or out of a subterranean formation. For example, a tubular can be placed underground to transport produced hydrocarbons or water from a subterranean formation to another location.

As used herein, the term “annulus” means the space between two generally cylindrical objects, one inside the other. The objects can be concentric or eccentric. Without limitation, one of the objects can be a tubular and the other object can be an enclosed conduit. The enclosed conduit can be a wellbore or borehole or it can be another tubular. The following are some non-limiting examples illustrate some situations in which an annulus can exist. Referring to an oil, gas, or water well, in an open hole well, the space between the outside of a tubing string and the borehole of the wellbore is an annulus. In a cased hole, the space between the outside of the casing the borehole is an annulus. In addition, in a cased hole there may be an annulus between the outside cylindrical portion of a tubular such as a production tubing string and the inside cylindrical portion of the casing. An annulus can be a space through which a fluid can flow or it can be filled with a material or object that blocks fluid flow, such as a packing element. Unless otherwise clear from the context, as used herein an annulus is a space through which a fluid can flow.

As used herein, a “well fluid” broadly refers to any fluid adapted to be introduced into a well for any purpose. A well fluid can be, for example, a drilling fluid, a cementing composition, a treatment fluid, or a spacer fluid. If a well fluid is to be used in a relatively small volume, for example less than about 200 barrels (about 8,400 US gallons or about 32 m³), it is sometimes referred to as a wash, dump, slug, or pill.

Drilling fluids, also known as drilling muds or simply “muds,” are typically classified according to their base fluid, that is, the nature of the continuous phase. A water-based mud (“WBM”) has a water phase as the continuous phase. The water can be brine. A brine-based drilling fluid is a water-based mud in which the aqueous component is brine. In some cases, oil may be emulsified in a water-based drilling mud. An oil-based mud (“OBM”) has an oil phase as the continuous phase. In some cases, a water phase is emulsified in the oil-based mud.

As used herein, the word “treatment” refers to any treatment for changing a condition of a portion of a wellbore or an adjacent subterranean formation; however, the word “treatment” does not necessarily imply any particular treatment purpose. A treatment usually involves introducing a well fluid for the treatment, in which case it may be referred to as a treatment fluid, into a well. As used herein, a “treatment fluid” is a fluid used in a treatment. The word “treatment” in the term “treatment fluid” does not necessarily imply any particular treatment or action by the fluid.

A zone refers to an interval of rock along a wellbore that is differentiated from uphole and downhole zones based on hydrocarbon content or other features, such as permeability, composition, perforations or other fluid communication with the wellbore, faults, or fractures. A zone of a wellbore that penetrates a hydrocarbon-bearing zone that is capable of producing hydrocarbon is referred to as a “production zone.” A “treatment zone” refers to an interval of rock along a wellbore into which a well fluid is directed to flow from the wellbore. As used herein, “into a treatment zone” means into and through the wellhead and, additionally, through the wellbore and into the treatment zone.

Generally, the greater the depth of the formation, the higher the static temperature and pressure of the formation. Initially, the static pressure equals the initial pressure in the formation before production. After production begins, the static pressure approaches the average reservoir pressure.

A “design” refers to the estimate or measure of one or more parameters planned or expected for a particular well fluid or stage of a well service. For example, a fluid can be designed to have components that provide a minimum viscosity for at least a specified time under expected downhole conditions. A well service may include design parameters such as fluid volume to be pumped, required pumping time for a treatment, or the shear conditions of the pumping.

The term “design temperature” refers to an estimate or measurement of the actual temperature at the downhole environment at the time of a well treatment. That is, design temperature takes into account not only the bottom hole static temperature (“BHST”), but also the effect of the temperature of the well fluid on the BHST during treatment. The design temperature is sometimes referred to as the bottom hole circulation temperature (“BHCT”). Because treatment fluids may be considerably cooler than BHST, the difference between the two temperatures can be quite large. Ultimately, if left undisturbed, a subterranean formation will return to the BHST.

Two fluids are incompatible if undesirable physical or chemical interactions occur when the fluids are mixed. Incompatibility is characterized by undesirable changes in apparent viscosity and shear stresses. When apparent viscosity of the mixed fluids is greater than apparent viscosity of each individual fluid, they are said to be incompatible at the tested shear rate.

The term “damage” as used herein refers to undesirable deposits in a subterranean formation that may reduce its permeability. Scale, skin, gel residue, and hydrates are contemplated by this term.

Physical States and Phases

As used herein, “phase” is used to refer to a substance having a chemical composition and physical state that is distinguishable from an adjacent phase of a substance having a different chemical composition or a different physical state.

As used herein, if not other otherwise specifically stated, the physical state or phase of a substance (or mixture of substances) and other physical properties are determined at a temperature of 77° F. (25° C.) and a pressure of 1 atmosphere (Standard Laboratory Conditions) without applied shear.

Particles and Particulates

As used herein, a “particle” refers to a body having a finite mass and sufficient cohesion such that it can be considered as an entity but having relatively small dimensions. A particle can be of any size ranging from molecular scale to macroscopic, depending on context.

A particle can be in any physical state. For example, a particle of a substance in a solid state can be as small as a few molecules on the scale of nanometers up to a large particle on the scale of a few millimeters, such as large grains of sand. Similarly, a particle of a substance in a liquid state can be as small as a few molecules on the scale of nanometers up to a large drop on the scale of a few millimeters. A particle of a substance in a gas state is a single atom or molecule that is separated from other atoms or molecules such that intermolecular attractions have relatively little effect on their respective motions.

As used herein, “particulate” or “particulate material” refers to matter in the physical form of distinct particles in a solid or liquid state (which means such an association of a few atoms or molecules). As used herein, a particulate is a grouping of particles having similar chemical composition and particle size ranges anywhere in the range of about 1 micrometer (e.g., microscopic clay or silt particles) to about 3 millimeters (e.g., large grains of sand).

A particulate can be of solid or liquid particles. As used herein, however, unless the context otherwise requires, particulate refers to a solid particulate. Of course, a solid particulate is a particulate of particles that are in the solid physical state, that is, the constituent atoms, ions, or molecules are sufficiently restricted in their relative movement to result in a fixed shape for each of the particles.

It should be understood that the terms “particle” and “particulate,” includes all known shapes of particles including substantially rounded, spherical, oblong, ellipsoid, rod-like, fiber, polyhedral (such as cubic materials), etc., and mixtures thereof. For example, the term “particulate” as used herein is intended to include solid particles having the physical shape of platelets, shavings, flakes, ribbons, rods, strips, spheroids, toroids, pellets, tablets or any other physical shape.

A particulate will have a particle size distribution (“PSD”). As used herein, “the size” of a particulate can be determined by methods known to persons skilled in the art.

One way to measure the approximate particle size distribution of a solid particulate is with graded screens. A solid particulate material will pass through some specific mesh (that is, have a maximum size; larger pieces will not fit through this mesh) but will be retained by some specific tighter mesh (that is, a minimum size; pieces smaller than this will pass through the mesh). This type of description establishes a range of particle sizes. A “+” before the mesh size indicates the particles are retained by the sieve, while a “−” before the mesh size indicates the particles pass through the sieve. For example, −70/+140 means that 90% or more of the particles will have mesh sizes between the two values.

Particulate materials are sometimes described by a single mesh size, for example, 100 U.S. Standard mesh. If not otherwise stated, a reference to a single particle size means about the mid-point of the industry-accepted mesh size range for the particulate.

Dispersions

A dispersion is a system in which particles of a substance of one chemical composition and physical state are dispersed in another substance of a different chemical composition or physical state. In addition, phases can be nested. If a substance has more than one phase, the most external phase is referred to as the continuous phase of the substance as a whole, regardless of the number of different internal phases or nested phases.

A dispersion can be classified different ways, including, for example, based on the size of the dispersed particles, the uniformity or lack of uniformity of the dispersion, and, if a fluid, whether or not precipitation occurs.

A dispersion is considered to be heterogeneous if the dispersed particles are not dissolved and are greater than about 1 nanometer in size. (For reference, the diameter of a molecule of toluene is about 1 nm).

Heterogeneous dispersions can have gas, liquid, or solid as an external phase. For example, in a case where the dispersed-phase particles are liquid in an external phase that is another liquid, this kind of heterogeneous dispersion is more particularly referred to as an emulsion. A solid dispersed phase in a continuous liquid phase is referred to as a sol, suspension, or slurry, partly depending on the size of the dispersed solid particulate.

A dispersion is considered to be homogeneous if the dispersed particles are dissolved in solution or the particles are less than about 1 nanometer in size. Even if not dissolved, a dispersion is considered to be homogeneous if the dispersed particles are less than about 1 nanometer in size.

Heterogeneous dispersions can be further classified based on the dispersed particle size.

A heterogeneous dispersion is a “suspension” where the dispersed particles are larger than about 50 micrometer. Such particles can be seen with a microscope, or if larger than about 50 micrometers (0.05 mm), with the unaided human eye. The dispersed particles of a suspension in a liquid external phase may eventually separate on standing, e.g., settle in cases where the particles have a higher density than the liquid phase. Suspensions having a liquid external phase are essentially unstable from a thermodynamic point of view; however, they can be kinetically stable over a long period depending on temperature and other conditions.

A heterogeneous dispersion is a “colloid” where the dispersed particles range up to about 50 micrometer (50,000 nanometers) in size. The dispersed particles of a colloid are so small that they settle extremely slowly, if ever. In some cases, a colloid can be considered as a homogeneous mixture. This is because the distinction between “dissolved” and “particulate” matter can be sometimes a matter of theoretical approach, which affects whether or not it is considered homogeneous or heterogeneous.

A solution is a special type of homogeneous mixture. A solution is considered homogeneous: (a) because the ratio of solute to solvent is the same throughout the solution; and (b) because solute will never settle out of solution, even under powerful centrifugation, which is due to intermolecular attraction between the solvent and the solute. An aqueous solution, for example, saltwater, is a homogenous solution in which water is the solvent and salt is the solute.

One may also refer to the solvated state, in which a solute ion or molecule is complexed by solvent molecules. A chemical that is dissolved in solution is in a solvated state. The solvated state is distinct from dissolution and solubility. Dissolution is a kinetic process, and is quantified by its rate. Solubility quantifies the concentration of the solute at which there is dynamic equilibrium between the rate of dissolution and the rate of precipitation of the solute. Dissolution and solubility can be dependent on temperature and pressure, and may be dependent on other factors, such as salinity or pH of a water phase.

Solubility

A substance is considered to be “soluble” in a liquid if at least 10 grams of the substance can be dissolved in one liter of the liquid when tested at 77° F. and 1 atmosphere pressure for 2 hours and considered to be “insoluble” if less soluble than this.

As will be appreciated by a person of skill in the art, the hydratability, dispersibility, or solubility of a substance in water can be dependent on the salinity, pH, or other substances in the water. Accordingly, the salinity, pH, and additive selection of the water can be modified to facilitate the hydratability, dispersibility, or solubility of a substance in aqueous solution. To the extent not specified, the hydratability, dispersibility, or solubility of a substance in water is determined in deionized water, at neutral pH, and without any other additives.

Fluids

A fluid can be a single phase or a dispersion. In general, a fluid is an amorphous substance that is or has a continuous phase of particles that are smaller than about 1 micrometer that tends to flow and to conform to the outline of its container.

Examples of fluids are gases and liquids. A gas (in the sense of a physical state) refers to an amorphous substance that has a high tendency to disperse (at the molecular level) and a relatively high compressibility. A liquid refers to an amorphous substance that has little tendency to disperse (at the molecular level) and relatively high incompressibility. The tendency to disperse is related to Intermolecular Forces (also known as van der Waal's Forces). (A continuous mass of a particulate, e.g., a powder or sand, can tend to flow as a fluid depending on many factors such as particle size distribution, particle shape distribution, the proportion and nature of any wetting liquid or other surface coating on the particles, and many other variables. Nevertheless, as used herein, a fluid does not refer to a continuous mass of particulate as the sizes of the solid particles of a mass of a particulate are too large to be appreciably affected by the range of Intermolecular Forces.)

As used herein, a fluid is a substance that behaves as a fluid under Standard Laboratory Conditions, that is, at 77° F. (25° C.) temperature and 1 atmosphere pressure, and at the higher temperatures and pressures usually occurring in subterranean formations without applied shear.

Every fluid inherently has at least a continuous phase. A fluid can have more than one phase. The continuous phase of a well fluid is a liquid under Standard Laboratory Conditions. For example, a well fluid can be in the form of be a suspension (solid particles dispersed in a liquid phase), an emulsion (liquid particles dispersed in another liquid phase), or a foam (a gas phase dispersed in a liquid phase).

As used herein, a water-based fluid means that water or an aqueous solution is the dominant material of the continuous phase, that is, greater than 50% by weight, of the continuous phase of the fluid.

In contrast, “oil-based” means that oil is the dominant material by weight of the continuous phase of the fluid. In this context, the oil of an oil-based fluid can be any oil.

In general, an oil is any substance that is liquid under Standard Laboratory Conditions, is hydrophobic, and soluble in organic solvents. Oils have a high carbon and hydrogen content and are relatively non-polar substances, for example, having a polarity of 3 or less on the Snyder polarity index. This general definition includes classes such as petrochemical oils, vegetable oils, and many organic solvents. All oils can be traced back to organic sources.

Emulsions

An emulsion is a fluid including a dispersion of immiscible liquid particles in an external liquid phase. In addition, the proportion of the external and internal phases is above the solubility of either in the other. A chemical can be included to reduce the interfacial tension between the two immiscible liquids to help with stability against coalescing of the internal liquid phase, in which case the chemical may be referred to as a surfactant or more particularly as an emulsifier or emulsifying agent.

In the context of an emulsion, a “water phase” refers to a phase of water or an aqueous solution, and an “oil phase” refers to a phase of any non-polar, organic liquid that is immiscible with water, usually an oil.

An emulsion can be an oil-in-water (o/w) type or water-in-oil (w/o) type. A water-in-oil emulsion is sometimes referred to as an invert emulsion.

It should be understood that multiple emulsions are possible. These are sometimes referred to as nested emulsions. Multiple emulsions are complex polydispersed systems where both oil-in-water and water-in-oil emulsions exist simultaneously in the fluid, wherein the oil-in-water emulsion is stabilized by a lipophilic surfactant and the water-in-oil emulsion is stabilized by a hydrophilic surfactant. These include water-in-oil-in-water (w/o/w) and oil-in-water-in-oil (o/w/o) type multiple emulsions. Even more complex polydispersed systems are possible. Multiple emulsions can be formed, for example, by dispersing a water-in-oil emulsion in water or an aqueous solution, or by dispersing an oil-in-water emulsion in oil.

A stable emulsion is an emulsion that will not cream, flocculate, or coalesce under certain conditions, including time and temperature. As used herein, the term “cream” means at least some of the droplets of a dispersed phase converge towards the surface or bottom of the emulsion (depending on the relative densities of the liquids making up the continuous and dispersed phases). The converged droplets maintain a discrete droplet form. As used herein, the term “flocculate” means at least some of the droplets of a dispersed phase combine to form small aggregates in the emulsion. As used herein, the term “coalesce” means at least some of the droplets of a dispersed phase combine to form larger drops in the emulsion.

Apparent Viscosity of a Fluid

Viscosity is a measure of the resistance of a fluid to flow. In everyday terms, viscosity is “thickness” or “internal friction.” Thus, pure water is “thin,” having a relatively low viscosity whereas honey is “thick,” having a relatively higher viscosity. Put simply, the less viscous the fluid is, the greater its ease of movement (fluidity). More precisely, viscosity is defined as the ratio of shear stress to shear rate.

A fluid moving along solid boundary will incur a shear stress on that boundary. The no-slip condition dictates that the speed of the fluid at the boundary (relative to the boundary) is zero, but at some distance from the boundary the flow speed must equal that of the fluid. The region between these two points is aptly named the boundary layer. For all Newtonian fluids in laminar flow, the shear stress is proportional to the strain rate in the fluid where the viscosity is the constant of proportionality. However for non-Newtonian fluids, this is no longer the case as for these fluids the viscosity is not constant. The shear stress is imparted onto the boundary as a result of this loss of velocity.

A Newtonian fluid (named after Isaac Newton) is a fluid for which stress versus strain rate curve is linear and passes through the origin. The constant of proportionality is known as the viscosity. Examples of Newtonian fluids include water and most gases. Newton's law of viscosity is an approximation that holds for some substances but not others.

Non-Newtonian fluids exhibit a more complicated relationship between shear stress and velocity gradient (i.e., shear rate) than simple linearity. Thus, there exist a number of forms of non-Newtonian fluids. Shear thickening fluids have an apparent viscosity that increases with increasing the rate of shear. Shear thinning fluids have a viscosity that decreases with increasing rate of shear. Thixotropic fluids become less viscous over time at a constant shear rate. Rheopectic fluids become more viscous over time at a constant sear rate. A Bingham plastic is a material that behaves as a solid at low stresses but flows as a viscous fluid at high stresses.

Most well fluids are non-Newtonian fluids. Accordingly, the apparent viscosity of a fluid applies only under a particular set of conditions including shear stress versus shear rate, which must be specified or understood from the context. As used herein, a reference to viscosity is actually a reference to an apparent viscosity. Apparent viscosity is commonly expressed in units of centipoise (“cP”).

Like other physical properties, the viscosity of a Newtonian fluid or the apparent viscosity of a non-Newtonian fluid may be highly dependent on the physical conditions, primarily temperature and pressure.

Viscosity and Gel Measurements

There are numerous ways of measuring and modeling viscous properties, and new developments continue to be made. The methods depend on the type of fluid for which viscosity is being measured. A typical method for quality assurance or quality control (QA/QC) purposes uses a couette device, such as a Fann Model 35 or 50 viscometer or a Chandler 5550 HPHT viscometer, that measures viscosity as a function of time, temperature, and shear rate. The viscosity-measuring instrument can be calibrated using standard viscosity silicone oils or other standard viscosity fluids.

Due to the geometry of most common viscosity-measuring devices, however, solid particulate, especially if larger than silt (larger than 74 micron), would interfere with the measurement on some types of measuring devices. Therefore, the viscosity of a fluid containing such solid particulate is usually inferred and estimated by measuring the viscosity of a test fluid that is similar to the fracturing fluid without any proppant or gravel that would otherwise be included. However, as suspended particles (which can be solid, gel, liquid, or gaseous bubbles) usually affect the viscosity of a fluid, the actual viscosity of a suspension is usually somewhat different from that of the continuous phase.

Unless otherwise specified, the apparent viscosity of a fluid (excluding any suspended solid particulate larger than silt) is measured with a Fann Model 35 type viscometer using an R1 rotor, B1 bob, and F1 torsion spring at a shear rate of 511 l/s (300 rpm), and at a temperature of 77° F. (25° C.) and a pressure of 1 atmosphere. For reference, the viscosity of pure water is about 1 cP.

As used herein, a fluid is considered to be “viscous” if it has an apparent viscosity greater than 20 cP. The viscosity of a viscous fluid is considered to break or be broken if the viscosity is greatly reduced. Preferably, although not necessarily for all applications depending on how high the initial viscosity of the fluid, the viscous fluid breaks to a viscosity of 20 cP or lower.

In regard to an emulsion, breaking can mean the creaming and coalescence of emulsified drops of the internal dispersed phase so that the internal phase separates out of the external phase. This can be visually observed as the formation of separate liquid layers. For example, breaking an emulsion can be accomplished mechanically (for example, in settlers, cyclones, or centrifuges), or via dilution, or with chemical additives to increase the surface tension of the internal droplets.

A substance is considered to be a fluid if it has an apparent viscosity less than 5,000 cP (independent of any gel characteristic).

Biodegradability

Biodegradable means the process by which complex molecules are broken down by micro-organisms to produce simpler compounds. Biodegradation can be either aerobic (with oxygen) or anaerobic (without oxygen). The potential for biodegradation is commonly measured on well fluids or their components to ensure that they do not persist in the environment. A variety of tests exist to assess biodegradation.

As used herein, a substance is considered “biodegradable” if the substance passes a ready biodegradability test or an inherent biodegradability test. It is preferred that a substance is first tested for ready biodegradability, and only if the substance does not pass at least one of the ready biodegradability tests then the substance is tested for inherent biodegradability.

In accordance with Organisation for Economic Co-operation and Development (OECD) guidelines, the following six tests permit the screening of chemicals for ready biodegradability. As used herein, a substance showing more than 60% biodegradability in 28 days according to any one of the six ready biodegradability tests is considered a pass level for classifying it as “readily biodegradable,” and it may be assumed that the substance will undergo rapid and ultimate degradation in the environment. The six ready biodegradability tests are: (1) 301A: DOC Die-Away; (2) 301B: CO2 Evolution (Modified Sturm Test); (3) 301C: MITI (I) (Ministry of International Trade and Industry, Japan); (4) 301D: Closed Bottle; (5) 301E: Modified OECD Screening; and (6) 301F: Manometric Respirometry. The six ready biodegradability tests are described below:

For the 301A test, a measured volume of inoculated mineral medium, containing 10 mg to 40 mg dissolved organic carbon per liter (DOC/1) from the substance as the nominal sole source of organic carbon, is aerated in the dark or diffuse light at 22±2° C. Degradation is followed by DOC analysis at frequent intervals over a 28-day period. The degree of biodegradation is calculated by expressing the concentration of DOC removed (corrected for that in the blank inoculum control) as a percentage of the concentration initially present. Primary biodegradation may also be calculated from supplemental chemical analysis for parent compound made at the beginning and end of incubation.

For the 301B test, a measured volume of inoculated mineral medium, containing 10 mg to 20 mg DOC or total organic carbon per liter from the substance as the nominal sole source of organic carbon is aerated by the passage of carbon dioxide-free air at a controlled rate in the dark or in diffuse light. Degradation is followed over 28 days by determining the carbon dioxide produced. The CO₂ is trapped in barium or sodium hydroxide and is measured by titration of the residual hydroxide or as inorganic carbon. The amount of carbon dioxide produced from the test substance (corrected for that derived from the blank inoculum) is expressed as a percentage of ThCO₂. The degree of biodegradation may also be calculated from supplemental DOC analysis made at the beginning and end of incubation.

For the 301C test, the oxygen uptake by a stirred solution, or suspension, of the substance in a mineral medium, inoculated with specially grown, unadapted micro-organisms, is measured automatically over a period of 28 days in a darkened, enclosed respirometer at 25+/−1° C. Evolved carbon dioxide is absorbed by soda lime. Biodegradation is expressed as the percentage oxygen uptake (corrected for blank uptake) of the theoretical uptake (ThOD). The percentage primary biodegradation is also calculated from supplemental specific chemical analysis made at the beginning and end of incubation, and optionally ultimate biodegradation by DOC analysis.

For the 301D test, a solution of the substance in mineral medium, usually at 2-5 milligrams per liter (mg/l), is inoculated with a relatively small number of micro-organisms from a mixed population and kept in completely full, closed bottles in the dark at constant temperature. Degradation is followed by analysis of dissolved oxygen over a 28 day period. The amount of oxygen taken up by the microbial population during biodegradation of the test substance, corrected for uptake by the blank inoculum run in parallel, is expressed as a percentage of ThOD or, less satisfactorily COD.

For the 301E test, a measured volume of mineral medium containing 10 to 40 mg DOC/1 of the substance as the nominal sole source of organic carbon is inoculated with 0.5 ml effluent per liter of medium. The mixture is aerated in the dark or diffused light at 22+2° C. Degradation is followed by DOC analysis at frequent intervals over a 28 day period. The degree of biodegradation is calculated by expressing the concentration of DOC removed (corrected for that in the blank inoculums control) as a percentage of the concentration initially present. Primary biodegradation may also be calculated from supplemental chemical analysis for the parent compound made at the beginning and end of incubation.

For the 301F test, a measured volume of inoculated mineral medium, containing 100 mg of the substance per liter giving at least 50 to 100 mg ThOD/1 as the nominal sole source of organic carbon, is stirred in a closed flask at a constant temperature (+1° C. or closer) for up to 28 days. The consumption of oxygen is determined either by measuring the quantity of oxygen (produced electrolytically) required to maintain constant gas volume in the respirometer flask or from the change in volume or pressure (or a combination of the two) in the apparatus. Evolved carbon dioxide is absorbed in a solution of potassium hydroxide or another suitable absorbent. The amount of oxygen taken up by the microbial population during biodegradation of the test substance (corrected for uptake by blank inoculum, run in parallel) is expressed as a percentage of ThOD or, less satisfactorily, COD. Optionally, primary biodegradation may also be calculated from supplemental specific chemical analysis made at the beginning and end of incubation, and ultimate biodegradation by DOC analysis.

In accordance with OECD guidelines, the following three tests permit the testing of chemicals for inherent biodegradability. As used herein, a substance with a biodegradation or biodegradation rate of >20% is regarded as “inherently primary biodegradable.” A substance with a biodegradation or biodegradation rate of >70% is regarded as “inherently ultimate biodegradable.” As used herein, a substance passes the inherent biodegradability test if the substance is either regarded as inherently primary biodegradable or inherently ultimate biodegradable when tested according to any one of three inherent biodegradability tests. The three tests are: (1) 302A: 1981 Modified SCAS Test; (2) 302B: 1992 Zahn-Wellens Test; and (3) 302C: 1981 Modified MITI Test. Inherent biodegradability refers to tests which allow prolonged exposure of the test compound to microorganisms, a more favorable test compound to biomass ratio, and chemical or other conditions which favor biodegradation. The three inherent biodegradability tests are described below:

For the 302A test, activated sludge from a sewage treatment plant is placed in an aeration (SCAS) unit. The substance and settled domestic sewage are added, and the mixture is aerated for 23 hours. The aeration is then stopped, the sludge allowed to settle and the supernatant liquor is removed. The sludge remaining in the aeration chamber is then mixed with a further aliquot of the substance and sewage and the cycle is repeated. Biodegradation is established by determination of the dissolved organic carbon content of the supernatant liquor. This value is compared with that found for the liquor obtained from a control tube dosed with settled sewage only.

For the 302B test, a mixture containing the substance, mineral nutrients, and a relatively large amount of activated sludge in aqueous medium is agitated and aerated at 20° C. to 25° C. in the dark or in diffuse light for up to 28 days. A blank control, containing activated sludge and mineral nutrients but no substance, is run in parallel. The biodegradation process is monitored by determination of DOC (or COD(2)) in filtered samples taken at daily or other time intervals. The ratio of eliminated DOC (or COD), corrected for the blank, after each time interval, to the initial DOC value is expressed as the percentage biodegradation at the sampling time. The percentage biodegradation is plotted against time to give the biodegradation curve.

For the 302C test, an automated closed-system oxygen consumption measuring apparatus (BOD-meter) is used. The substance to be tested is inoculated in the testing vessels with micro-organisms. During the test period, the biochemical oxygen demand is measured continuously by means of a BOD-meter. Biodegradability is calculated on the basis of BOD and supplemental chemical analysis, such as measurement of the dissolved organic carbon concentration, concentration of residual chemicals, etc.

General Measurement Terms

Unless otherwise specified or unless the context otherwise clearly requires, any ratio or percentage means by weight.

If there is any difference between U.S. or Imperial units, U.S. units are intended. For example, “gal/Mgal” means U.S. gallons per thousand U.S. gallons.

Unless otherwise specified, mesh sizes are in U.S. Standard Mesh.

The micrometer (μm) may sometimes be referred to herein as a micron.

### GENERAL DESCRIPTION OF THE INVENTION

An approach to increasing the viscosity of a fluid is the use of an emulsion. The internal-phase droplets of an emulsion disrupt flow streamlines and require more effort to get the same flow rate. Thus, an emulsion tends to have a higher viscosity than the continuous phase of the emulsion would otherwise have by itself. This property of an emulsion can be used, for example, to help suspend a particulate material in an emulsion.

Emulsions are widely used in oilfield applications such as drilling fluids, carrier fluids, etc. In applications for placement of a particulate in a zone of a well, the emulsions are usually required to have a high viscosity (that is, greater than 200 cP). In addition, it is usually required that after placement of the particulate, the emulsion viscosity be reduced for effective fluid flow back after the job.

If the viscosity is broken too soon, the delivery and proper placement of the particulate in the zone may not be achieved. If the viscosity is not adequately broken after delivery and placement of the particulate, the high emulsion viscosity may lead to clogging of pore spaces and permeability losses in the subterranean formation or particulate pack during production. Good post-job carrier fluid cleanup and flow back is therefore essential for enhanced productivity in applications such as gravel packing. Finally, it is normally desirable that the breaking of the emulsion should occur as shortly as possible after placement of the particulate, which reduces waiting time. Of course, safety margins of time should be built into a job design. Accordingly, the invert emulsion break should take place in a controllable manner only after effective delivery of the suspended particulate to a desired zone in a well, but reliably and shortly after because well servicing jobs require expensive equipment and personnel time. This requires that an invert emulsion meet a critical job design balance, which has high financial consequences for premature breaking, incomplete breaking, or unnecessarily wasted time waiting on the breaking of the emulsion.

Oil external emulsions with aqueous internal phase formed with non-ionic surfactants are stable at neutral pH. These can be broken by increasing the pH towards alkaline pH of approximately greater than about pH 8. However, strong bases like sodium hydroxide tend to break these emulsions instantaneously. Although weak bases like sodium acetate will break the emulsions relatively slowly, they will cause viscosity reduction that may lead to premature settling of the suspended solids and eventual job failure. Thus, it is required for the emulsion to break in a controllable manner.

This invention provides a controllable emulsion break mechanism to break the viscosity of such an invert emulsion for effective cleanup in a well. Controlled breaking is achieved by controlling the release of a breaker, that is, controlled release of a breaker encapsulated by an encapsulant. More particularly, according to the invention, the controlled release of the breaker is achieved by diffusion without dissolving or degradation of the encapsulant. For example, the encapsulant does not dissolve or degrade for at least the length of the job design time before any flowback. However, other considerations exist, including that the encapsulating material be biodegradable, and, preferably, be considered non-toxic to fish and animal life.

As used herein, the term “controlled breaking” in regard to the use of an encapsulant refers to the breaking of a treatment fluid is delayed by at least fifteen minutes, relative to breaking that would be obtained without encapsulating the breaker, all else with the fluid and job design conditions being equal. Preferably, the controlled breaking is within 24 hours under the job design conditions.

The invert emulsions can be of high viscosity adapted for carrying a particulate, such as gravel for use in gravel packing. Timely breaking the viscosity of the emulsion according to the job design requirements effectively reduces the viscosity to a much lower viscosity for effective cleanup of the fluids from the well. Other benefits and advantages to using emulsions and methods according to the invention will be evident to one of ordinary skill in the art.

According to the invention, the encapsulant is selected for having properties that help in the controlled breaking. For example, the encapsulant material is a protective material that at least temporarily and at least partially physically separates the breaker from a surrounding water phase of an emulsion, such that the dispersing or dissolving into the surrounding liquid phase is controlled. Among other things, the encapsulant is selected for being thermally stable to the design temperature for the treatment in the well. By way of another example, the encapsulant is selected for being chemically stable to direct contact with the breaker. The nature (e.g., length) of the delay will depend largely on the specific breaker, the encapsulant, and concentrations used. In addition, the encapsulating material is selected for being biodegradable. Preferably, the encapsulating material is also selected for being non-toxic to fish and animal life. For example, the encapsulating material preferably comprises materials that can pass current North Sea environmental regulations for oil wells.

The encapsulated break compositions of the present invention are particularly useful at relatively high temperature ranges (e.g., up to about 149° C. or 300° F.). It is believed that these temperatures are significantly higher than the workable temperature ranges for conventional encapsulated breakers, which represents a distinct advantage. At such relatively high temperatures, breaking tends to occurs rapidly and is difficult to control.

### Emulsion

According to an embodiment of the invention, an emulsion is provided, the emulsion including: (a) an external oil phase, wherein the oil phase has a viscosity of less than 200 cP; (b) an internal water phase adjacent the external phase, wherein the internal water phase has a pH in the range of 5 to 9; (c) an emulsifier having a hydrophilic-lipophilic balance (“HLB”) in the range of 3 to 7 on the Davies scale; and (d) a Bronsted-Lowry base having a pKb(1) less than 12, wherein the base is encapsulated with an encapsulated breaker composition comprising: an encapsulant that comprises an ether cellulose. In a preferred embodiment, the emulsion has a viscosity greater than 200 cP.

In an embodiment, the external oil phase and the internal water phase are in a ratio in the range of 50:50 to 95:5 by volume. For example, in an embodiment, the emulsion can include about 30% of an external or continuous oil phase and about 70% of a suitable internal water phase.

In an embodiment, an emulsion according to the invention has a viscosity greater than 20 cP. In another embodiment, an emulsion has a high viscosity of at least 200 cP. Breaking would be measured as having a viscosity of less than 20 cP. Alternatively, breaking can be visually observed.

External Oil Phase

In an embodiment, the external phase is the continuous phase of a well fluid. The external oil phase has a viscosity of less than 200 cP. Preferably, the external oil phase has a viscosity of less than 20 cP.

In an embodiment, the oil phase includes an a natural or synthetic source of an oil. Examples of oils from natural sources include, without limitation, kerosene, diesel oils, crude oils, gas oils, fuel oils, paraffin oils, mineral oils, low toxicity mineral oils, other petroleum distillates, and combinations thereof. Examples of synthetic oils include, without limitation, polyolefins, polydiorganosiloxanes, siloxanes, organosiloxanes.

In an embodiment, the external phase has less than a sufficient concentration of any polyvalent metal salt therein to gel the external phase. For example, the external phase is not gelled with a polyvalent metal salt of an organophosphonic acid ester or a polyvalent metal salt of an organophosphinic acid. Preferably, the external phase is substantially free of any polyvalent metal salt compound.

Internal Water Phase

In an embodiment, the internal water phase includes at least 50% by weight water, excluding the weight of any dissolved salts or other dissolved solids.

In an embodiment, the internal phase comprises a dissolved salt. The dissolved salt can be selected from the group consisting of: sodium chloride, calcium chloride, calcium bromide, zinc bromide, sodium formate, potassium formate, sodium acetate, potassium acetate, calcium acetate, ammonium acetate, ammonium chloride, ammonium bromide, zinc bromide, sodium nitrate, potassium nitrate, ammonium nitrate, calcium nitrate, and any combination thereof. A purpose of a dissolved salt can be, among other things, to add to the density of the emulsion.

For example, a suitable internal water phase can include, without limitation, fresh water, seawater, salt water (e.g., saturated or unsaturated), and brines (e.g., saturated salt waters). Suitable brines can include heavy brines.

In an embodiment, the internal water phase can comprise a salt substitute, for example, trimethyl ammonium chloride.

In an embodiment, the internal water phase has a pH in the range of 5 to 9. More preferably, the internal water phase has a pH in the range of 5 to 8.

In certain embodiments, the water phase can include a pH-adjuster. Preferably, the pH adjuster does not have undesirable properties for the treatment fluid. A pH-adjuster can be present in the water phase in an amount sufficient to adjust the pH of the fluid to within the desired range.

In general, a pH-adjuster may function, inter alia, to affect the hydrolysis rate of the viscosity-increasing agent. In some embodiments, a pH-adjuster may be included in the treatment fluid, inter alia, to adjust the pH of the treatment fluid to, or maintain the pH of the treatment fluid near, a pH that balances the duration of certain properties of the treatment fluid (e.g. the ability to suspend particulate) with the ability of the breaker to reduce the viscosity of the treatment fluid or a pH that will result in a decrease in the viscosity of the treatment fluid such that it does not hinder production of hydrocarbons from the formation.

One of ordinary skill in the art, with the benefit of this disclosure, will recognize the appropriate pH-adjuster and amount thereof to use for a chosen application according to this disclosure.

Emulsifier

Surfactants are compounds that lower the surface tension of a liquid, the interfacial tension between two liquids, or that between a liquid and a solid. Surfactants may act as detergents, wetting agents, emulsifiers, foaming agents, and dispersants.

Surfactants are usually organic compounds that are amphiphilic, meaning they contain both hydrophobic groups (“tails”) and hydrophilic groups (“heads”). Therefore, a surfactant contains both a water insoluble (or oil soluble) component and a water soluble component.

In a water phase, surfactants form aggregates, such as micelles, where the hydrophobic tails form the core of the aggregate and the hydrophilic heads are in contact with the surrounding liquid. Other types of aggregates such as spherical or cylindrical micelles or bilayers can be formed. The shape of the aggregates depends on the chemical structure of the surfactants, depending on the balance of the sizes of the hydrophobic tail and hydrophilic head.

As used herein, the term micelle includes any structure that minimizes the contact between the lyophobic (“solvent-repelling”) portion of a surfactant molecule and the solvent, for example, by aggregating the surfactant molecules into structures such as spheres, cylinders, or sheets, wherein the lyophobic portions are on the interior of the aggregate structure and the lyophilic (“solvent-attracting”) portions are on the exterior of the structure. Micelles can function, among other purposes, to stabilize emulsions, break emulsions, stabilize a foam, change the wettability of a surface, solubilize certain materials, or reduce surface tension.

As used herein, an emulsifier refers to a type of surfactant that helps prevent the droplets of the dispersed phase of an emulsion from flocculating or coalescing in the emulsion.

An emulsifier can be or include a cationic, a zwitterionic, or a nonionic emulsifier. A surfactant package can include one or more different chemical surfactants.

The hydrophilic-lipophilic balance (“HLB”) of a surfactant is a measure of the degree to which it is hydrophilic or lipophilic, determined by calculating values for the different regions of the molecule, as described by Griffin in 1949 and 1954. Other methods have been suggested, notably in 1957 by Davies.)

In general, Griffin's method for non-ionic surfactants as described in 1954 works as follows:

HLB=20*Mh/M

where Mh is the molecular mass of the hydrophilic portion of the molecule, and M is the molecular mass of the whole molecule, giving a result on a scale of 0 to 20. An HLB value of 0 corresponds to a completely lipidphilic/hydrophobic molecule, and a value of 20 corresponds to a completely hydrophilic/lypidphobic molecule. Griffin WC: “Classification of Surface-Active Agents by ‘HLB,’” Journal of the Society of Cosmetic Chemists 1 (1949): 311. Griffin WC: “Calculation of HLB Values of Non-Ionic Surfactants,” Journal of the Society of Cosmetic Chemists 5 (1954): 249.

The HLB (Griffin) value can be used to predict the surfactant properties of a molecule, where a value less than 10 indicates that the surfactant molecule is lipid soluble (and water insoluble), whereas a value greater than 10 indicates that the surfactant molecule is water soluble (and lipid insoluble).

In addition, the HLB (Griffin) value can be used to predict the uses of the molecule, where: a value from 4 to 8 indicates an anti-foaming agent, a value from 7 to 11 indicates a W/O (water in oil) emulsifier, a value from 12 to 16 indicates O/W (oil in water) emulsifier, a value from 11 to 14 indicates a wetting agent, a value from 12 to 15 indicates a detergent, and a value of 16 to 20 indicates a solubiliser or hydrotrope.

In 1957, Davies suggested an extended HLB method based on calculating a value based on the chemical groups of the molecule. The advantage of this method is that it takes into account the effect of stronger and weaker hydrophilic groups. The method works as follows:

HLB=7+m*Hh−n*H1

where m is the number of hydrophilic groups in the molecule, Hh is the value of the hydrophilic groups, n is the number of lipophilic groups in the molecule, and H1 is the value of the lipophilic groups. The specific values for the hydrophilic and hydrophobic groups are published. See, e.g., Davies JT: “A quantitative kinetic theory of emulsion type, I. Physical chemistry of the emulsifying agent,” Gas/Liquid and Liquid/Liquid Interface. Proceedings of the International Congress of Surface Activity (1957): 426-438.

The HLB (Davies) model can be used for applications including emulsification, detergency, solubilization, and other applications. Typically a HLB (Davies) value will indicate the surfactant properties, where a value of 1 to 3 indicates anti-foaming of aqueous systems, a value of 3 to 7 indicates W/O emulsification, a value of 7 to 9 indicates wetting, a value of 8 to 28 indicates O/W emulsification, a value of 11 to 18 indicates solubilization, and a value of 12 to 15 indicates detergency and cleaning.

In an embodiment, the emulsifier is selected from the group consisting of: polyaminated fatty acids and their salts, quaternary ammonium compounds, and tallow based compounds.

In an embodiment, the emulsifier is a non-ionic emulsifier.

In an embodiment, the emulsion includes an emulsifier having a HLB (Davies scale) in the range of 3 to 7.

The emulsifier is preferably in a concentration of at least 0.1% by weight of the water of the emulsion. More preferably, the emulsifier is in a concentration in the range of 1% to 10% by weight of the water phase.

Base to Break Emulsion

In an embodiment, the breaker is a Bronsted-Lowry base having a pKb(1) less than 12. Preferably, the base is a weak base.

The breaker should be in a sufficient concentration to increase the pH of the internal water phase to greater than 8. More preferably, the breaker should be in a sufficient concentration to increase the pH of the water phase to greater than 9.

In an embodiment, the Bronsted-Lowry base is an alkali metal acetate, such as sodium acetate.

A basic pH of the water phase breaks the water in oil emulsion formed using a non-ionic emulsifier by initially reducing the viscosity of the emulsion followed by complete phase separation. However, upon sufficient increase in the pH, the process of viscosity reduction and breaking the emulsion occurs nearly instantaneously, which may lead to premature settling of the suspended solids.

Encapsulant to Control Release of Base

To achieve a controllable break of the emulsion, the base, such as sodium acetate, is coated or otherwise formed with water-insoluble, but permeable polymeric material. In an embodiment, the encapsulant is or includes ethyl cellulose.

In an embodiment, the encapsulant additionally comprises an impermeable inert material, which can provide additional controlled release. In a presently preferred embodiment, the impermeable inert material is or includes poly(methyl methacrylate) (“PMMA”).

In an embodiment, other polymeric materials can optionally be included in the encapsulant. For example, other polymeric materials that may be suitable include, without limitation, gelatin, starch, shellac, poly(methyl methacrylate), polyvinylidene chloride, titanium dioxide, and any combinations of these.

In an embodiment, other degradable polymers can be included in the encapsulant. Examples of suitable degradable polymers include, but are not limited to, polysaccharides (such as dextran or cellulose); chitins; chitosans; proteins; aliphatic polyesters; polylactic acids; poly(glycolides); poly(ε-caprolactones); poly(hydroxy ester ethers); poly(hydroxybutyrates); poly(anhydrides); aliphatic polycarbonates; orthoester; poly(orthoesters); poly(amino acids); poly(ethylene oxides); poly(phosphazenes); poly etheresters, polyester amides, polyamides, and copolymers or blends of any of these degradable materials.

The base can be encapsulated with the encapsulant according to any suitable technique. For example, one or more polymeric materials for a suitable encapsulant according to the invention can be dissolved in a suitable solvent or solvent mixture. Solvents which can be used for encapsulation should have dipole moment in the range 1.04 to 3.92. Examples of suitable solvents include dichloromethane, acetone, and dimelthylformamide (“DMF”). The base is also dispersed or dissolved in the solvent. The solution can be dried to yield an encapsulated breaker in the form of a particulate.

The encapsulated base can be made using microencapsulation or spray drying techniques. The preferred encapsulation techniques include, but are not limited to, a fluidized bed process such as the Wurster process and a modified Wurster process utilizing a top spray method. A spray drying process may also be used as a suitable encapsulation technique.

In some embodiments, the breaker is present in an amount ranging from about 5 to about 35% by weight of the encapsulant. In some embodiment, the breaker is present in an amount ranging from about 25 to about 30 by weight of the encapsulant.

In some embodiments, the viscosified treatment fluid can also comprise unencapsulated breakers. Such mixtures of encapsulated and unencapsulated breakers should control the breaking process when desirable.

A presently preferred encapsulant includes an alkyl cellulose, also known as cellulose ether. An example of a cellulose ether is ethyl cellulose.

Cellulose ethers are high-molecular-weight compounds produced by replacing the hydrogen atoms of hydroxyl groups in the anhydroglucose units of cellulose with alkyl or substituted alkyl groups. For example, ethly cellulose is a derivative of cellulose in which some of the hydroxyl groups on the repeating glucose units are converted into ethyl ether groups. The number of ethyl groups can vary.

The encapsulated breaker compositions of the present invention can additionally include a less permeable encapsulant material to help control the release of the base into the water phase.

A preferred example of such an impermeable encapsulant material comprises a polymethacrylate. The term polymethacrylate as used herein refers to a polymer comprising homopolymer or copolymer made from acrylate and methacrylate. In some embodiments, the encapsulant is a blend of poly(methyl methacrylate) and poly methyl methacrylate-co-ethyl acrylate-co-S trimethylaminoethyl methacrylate chloride (P(MMA-EA-TMAEMC)).

Preferably, the polymethacrylate exhibits lower permeability to the emulsion phases than the permeable polymeric material, particularly the internal phase, which, in turn, leads to additional control of the release of the base. For example, to further to control the release of sodium acetate, the highly permeable alkyl cellulose is mixed with small amount (for example, less than 10% by weight relative to the alkyl cellulose) of impermeable inert material such as poly(methyl methacrylate) (PMMA) to achieve desired slow release. The inclusion of an impermeable inert material helps in controlling the permeability of ethyl cellulose.

Particulate in Treatment Fluid

In certain applications, the treatment fluid can include a particulate. A particulate, such as proppant or gravel, can be used. Examples include sand, gravel, bauxite, ceramic materials, glass materials, polymer materials, wood, plant and vegetable matter, nut hulls, walnut hulls, cottonseed hulls, cured cement, fly ash, fibrous materials, composite particulates, hollow spheres or porous particulate.

The particulate used for gravel packing is referred to as “gravel.” In the oil and gas field, and as used herein, the term “gravel” is refers to relatively large particles in the sand size classification, that is, particles ranging in diameter from about 0.1 mm up to about 2 mm. Generally, a particulate having the properties, including chemical stability, of a low-strength proppant is used in gravel packing. An example of a commonly used gravel packing material is sand having an appropriate particulate size range.

Further, a suitable gravel should be stable over time and not dissolve in fluids commonly encountered in a well environment. Preferably, a gravel material is selected that will not dissolve in water or crude oil.

Suitable gravel materials include, but are not limited to, sand (silica), ground nut shells or fruit pits, sintered bauxite, glass, plastics, ceramic materials, processed wood, resin coated sand or ground nut shells or fruit pits or other composites, and any combination of the foregoing. Mixtures of different kinds or sizes of gravel can be used as well.

The concentration of gravel in the treatment fluid depends on the nature of the subterranean formation. As the nature of subterranean formations differs widely, the concentration of proppant in the treatment fluid may be in the range of from about 0.03 kilograms to about 12 kilograms of gravel per liter of liquid phase (from about 0.1 lb/gal to about 25 lb/gal).

In addition, particulate that has been chemically treated or coated may also be used. The term “coated” does not imply any particular degree of coverage of the particulates with the resin or tackifying agent.

In some embodiments, resin or tackifying agent coated particulates may be suitable for use in the treatment fluids. As used herein, the term “resinous material” means a material that is a viscous liquid and has a sticky or tacky characteristic when tested under Standard Laboratory Conditions. A resinous material can include a resin, a tackifying agent, and any combination thereof in any proportion. The resin can be or include a curable resin.

Other Well Fluid Additives

A well fluid can contain additives that are commonly used in oil field applications, as known to those skilled in the art. These include, but are not necessarily limited to, oxygen scavengers, thermal stabilizers, alcohols, scale inhibitors, corrosion inhibitors, hydrate inhibitors, fluid-loss control additives, oxidizers, chelating agents, water control agents (such as relative permeability modifiers), consolidating agents, particulate flowback control agents, conductivity enhancing agents, clay stabilizers, sulfide scavengers, fibers, bactericides, and any combination thereof.

Method of Treating a Well with the Emulsion

According to another embodiment of the invention, a method of treating a well, is provided, the method including the steps of: forming a treatment fluid including an emulsion according to the invention; and introducing the treatment fluid into the well.

Forming Well Fluid

A well fluid can be prepared at the job site, prepared at a plant or facility prior to use, or certain components of the well fluid can be pre-mixed prior to use and then transported to the job site. Certain components of the well fluid may be provided as a “dry mix” to be combined with fluid or other components prior to or during introducing the well fluid into the well.

In certain embodiments, the preparation of a well fluid can be done at the job site in a method characterized as being performed “on the fly.” The term “on-the-fly” is used herein to include methods of combining two or more components wherein a flowing stream of one element is continuously introduced into flowing stream of another component so that the streams are combined and mixed while continuing to flow as a single stream as part of the on-going treatment. Such mixing can also be described as “real-time” mixing.

Introducing into Well or Zone

Often the step of delivering a well fluid into a well is within a relatively short period after forming the well fluid, e.g., less within 30 minutes to one hour. More preferably, the step of delivering the well fluid is immediately after the step of forming the well fluid, which is “on the fly.”

It should be understood that the step of delivering a well fluid into a well can advantageously include the use of one or more fluid pumps.

Gravel Packing

In an embodiment, the step of introducing comprises introducing under conditions for gravel packing the treatment zone.

Allowing Time for Breaking in the Well

After the step of introducing a well fluid according to the invention, an embodiment of the method includes allowing time for breaking of the fluid in the well. This preferably occurs with time under the conditions in the zone of the subterranean fluid.

Flow Back Conditions

In an embodiment, the step of flowing back is within 24 hours of the step of introducing. In another embodiment, the step of flowing back is within 16 hours of the step of introducing.

Producing Hydrocarbon from Subterranean Formation

Preferably, after any such well treatment, a step of producing hydrocarbon from the subterranean formation is the desirable objective.

### Advantages

A water-in-oil emulsion allows more efficient gravel packing application in horizontal wells comprising shale sensitive formation.

A controllable emulsion break can be achieved using an encapsulated weak base such as sodium acetate for effective cleanup after the job.

An emulsion according to the invention gives more control over the placement of the particulate matter followed by effective flow back. This avoids premature settling and effective flow back of the carrier fluid after the job.

The encapsulated invert emulsion breaker can be added as an internal component of the emulsion thus avoiding additional remedial treatment costs for post job unbroken emulsion cleanup

An alkyl cellulose is a based on a naturally occurring material and has good environmental rating.

Overall, the inventions can provide an increase in job success along with good environmental rating is expected.

### Examples

To facilitate a better understanding of the present invention, the following examples of certain aspects of some embodiments are given. In no way should the following examples be read to limit, or define, the entire scope of the invention.

Two different encapsulants in the invention were tested. In one test, sodium acetate was encapsulated in ethyl cellulose, which is a water-insoluble but permeable polymeric material. More particularly, 30% by weight of sodium acetate was encapsulated with ethyl cellulose so as to achieve desire break of emulsion over a period of time. In preparation of encapsulated sodium acetate, initially 2.8 gram ethyl cellulose was dissolved in 8 ml of dichloromethane and then sodium acetate was added and dissolved by stirring. The solution obtained was dispensed by pipette out into droplets that were dried rapidly to yield circular flakes. The diameter and thickness of the flakes was in the range 1.5 mm and 0.5 mm, respectively. The concentration of the solution was selected so as to achieve rapid drying upon formation of droplets.

In another test, adapted to illustrate further control of the release of sodium acetate, the highly permeable ethyl cellulose was mixed with small amount (less than 5% by weight relative to the alkyl cellulose) of an impermeable inert material. More particularly, the impermeable polymeric material was poly(methyl methacrylate) (PMMA). This test encapsulant composition was otherwise formulated and prepared similar to the one without the impermeable inert material. The inclusion of an impermeable inert material helps in controlling the permeability of ethyl cellulose.

A test emulsion was prepared having an external (continuous) oil phase and an internal water phase in a ratio of 30:70 v/v. More particularly, the oil phase was “HDF-2000”™ mineral oil, commercially available from TOTAL-Fina. The water phase was NaBr brine having a density of 11.35 pound per gallon. The emulsifier was “BDF-364”™ in a concentration of 20 gal/Mgal. This emulsifier is a non-ionic, water-in-oil emulsifier having a North Sea rating of “Yellow,” which is commercially available from Halliburton Energy Services, Inc. This is the basic emulsion used in each of the following tests.

In a break test with neat (non-encapsulated) sodium acetate added in a concentration of 0.01 g/ml of the emulsion, the emulsion breaks after only 45 minutes under Standard Laboratory Conditions. The initial emulsion viscosity was measured at 250 cP at 75° F. After 45 minutes standing under Standard Laboratory Conditions, the final emulsion viscosity had broken to less than 30 cP at 75° F.

In a break test with sodium acetate encapsulated with only ethyl cellulose added in a concentration of 0.017 g/ml (including both the sodium acetate and the encapsulant), the emulsion breaks in 12 hours at 150° F.

In a break test with sodium acetate encapsulated with both the ethyl cellulose and PMMA encapsulant added in a concentration of 0.017 g/ml (including both the sodium acetate and the encapsulant), the emulsion breaks after 18 hours at 150° F.

For sand suspension testing, sand in a concentration of 5 pound per gallon was added to the basic emulsion composition. The sand was 20-40 US Mesh. When tested with sodium acetate encapsulated with only ethyl cellulose added in a concentration of 0.017 g/ml (including both the sodium acetate and the encapsulant) at about 75° F., no phase separation or sand settling was observed at 1 hour. Even when tested at 150° F., no phase separation or sand settling was observed at 2 hours.

### CONCLUSION

Therefore, the present invention is well adapted to attain the ends and advantages mentioned as well as those that are inherent therein.

The particular embodiments disclosed above are illustrative only, as the present invention may be modified and practiced in different but equivalent manners apparent to those skilled in the art having the benefit of the teachings herein. It is, therefore, evident that the particular illustrative embodiments disclosed above may be altered or modified and all such variations are considered within the scope and spirit of the present invention.

The various elements or steps according to the disclosed elements or steps can be combined advantageously or practiced together in various combinations or sub-combinations of elements or sequences of steps to increase the efficiency and benefits that can be obtained from the invention.

The invention illustratively disclosed herein suitably may be practiced in the absence of any element or step that is not specifically disclosed or claimed.

Furthermore, no limitations are intended to the details of construction, composition, design, or steps herein shown, other than as described in the claims.

What is claimed is:

1. An emulsion comprising:
(A) an external oil phase, wherein the oil phase has a viscosity of less than 200 cP;
(B) an internal water phase adjacent the external phase, wherein the internal water phase has a pH in the range of 5 to 8;
(C) an emulsifier having a hydrophilic-lipophilic balance in the range of 3 to 7 on the Davies scale; and
(D) a Bronsted-Lowry base having a pKb(1) less than 12, wherein the base is encapsulated with an encapsulated breaker composition comprising: an encapsulant that comprises an ether cellulose.

2. The emulsion according to claim 1, wherein the external oil phase is the continuous phase of a fluid.

3. The emulsion according to claim 1, wherein the internal water phase comprises a dissolved salt.

4. The emulsion according to claim 1, wherein the external oil phase and the internal water phase are in a ratio in the range of 50:50 to 95:5 by volume.

5. The emulsion according to claim 1, wherein the emulsion has a viscosity greater than 200 cP.

6. The emulsion according to claim 1, wherein the emulsifier is selected from the group consisting of: polyaminated fatty acids and their salts, quaternary ammonium compounds, and tallow based compounds.

7. The emulsion according to claim 1, wherein the Bronsted-Lowry base is an alkali metal acetate.

8. The emulsion according to claim 1, wherein the encapsulant comprises ethyl cellulose.

9. The emulsion according to claim 1, wherein the encapsulant additionally comprises an impermeable inert material.

10. The emulsion according to claim 1, wherein the impermeable inert material comprises poly(methyl methacrylate) (“PMMA”).

11. A method of treating a well, the method comprising the steps of:
(A) forming a treatment fluid comprising an emulsion, wherein the emulsion comprises:
(1) an external oil phase, wherein the oil phase has a viscosity of less than 200 cP;
(2) an internal water phase adjacent the external phase, wherein the internal water phase has a pH in the range of 5 to 9;
(3) an emulsifier having a hydrophilic-lipophilic balance in the range of 3 to 7; and
(4) a Bronsted-Lowry base having a pKb(1) less than 12, wherein the base is encapsulated with an encapsulated breaker composition comprising: an encapsulant that comprises an ether cellulose; and
(B) introducing the treatment fluid into the well.

12. The method according to claim 11, wherein the external oil phase is the continuous phase of the treatment fluid.

13. The method according to claim 11, wherein the internal water phase comprises a dissolved salt.

14. The method according to claim 11, wherein the external oil phase and the internal water phase are in a ratio in the range of 50:50 to 95:5 by volume.

15. The method according to claim 11, wherein the emulsion has a viscosity greater than 200 cP.

16. The method according to claim 11, wherein the emulsifier is selected from the group consisting of: polyaminated fatty acids and their salts, quaternary ammonium compounds, and tallow based compounds.

17. The method according to claim 11, wherein the Bronsted-Lowry base is an alkali metal acetate.

18. The method according to claim 11, wherein the encapsulant comprises ethyl cellulose.

19. The method according to claim 11, wherein the encapsulant additionally comprises an impermeable inert material.

20. The method according to claim 11, wherein the impermeable inert material comprises poly(methyl methacrylate) (“PMMA”).

21. The method according to claim 11, wherein the treatment fluid additionally comprises a solid particulate.

22. The method according to claim 11, additionally comprising the step of allowing time for breaking of the emulsion of the treatment fluid in the well.
